(19) United States
(12) Patent Application Publication
(10) Pub. No.: US 2007/0266874 A1
(43) Pub. Date: Nov. 22, 2007

(54) Method and Apparatus for Optimally Adjusting the Infeed in a Rotary Flexographic Printing Press Comprising Multiple Printing Units

(75) Inventors: Sabine KARLA, Bielefeld (DE); Volker REINHOLDT, Bielefeld (DE); Andreas PIETIG, Harsewinkel (DE); Bernd MORGENSTERN, Leipzig (DE)

Correspondence Address: TIMOTHY F. BLISS, P.O. BOX 793968, DALLAS, TX, 75379, US

(73) Assignee: ELTROMAT GMBH, Leopoldshohe (DE)

(21) Appl. No.: 11/692,891

(22) Filed: Mar. 28, 2007

(30) Foreign Application Priority Data
Mar. 31, 2006 (EP) 06006844.2

(51) Int. Cl. B41F 13/14

(52) U.S. Cl. 101/480; 101/486

(57) ABSTRACT

Provided are a method and apparatus for optimally adjusting a printing press having multiple printing units. In one example, for each printing unit, relative positions are calculated between an anilox roll and a form cylinder that form a first cylinder pair and between the form cylinder and an impression cylinder that form a second cylinder pair. Calculations based on colour selective detection of printing marks are performed to identify adjustment parameters for the relative positions of the first and second cylinder pairs, and one or more of the relative positions are adjusted.

### CLAIM OF PRIORITY

This application claims priority from European Patent Application No. 06006844.2, filed on Mar. 31, 2006, which is incorporated herein by reference in its entirety.

### FIELD OF THE INVENTION

The invention relates to rotary printing presses.

### BACKGROUND

Current printing press apparatuses have adjustment issues that negatively impact their operation. Accordingly, an improved printing press apparatus and a method of using such an apparatus are needed.

### SUMMARY

In one embodiment, a method comprises calculating, for each of a plurality of printing units in a printing press, a relative position between an anilox roll and a form cylinder that form a first cylinder pair and a relative position between the form cylinder and an impression cylinder that form a second cylinder pair, wherein the impression cylinder guides a material web for a printing process. A plurality of printing marks having different and known nominal tonal values are printed onto different locations of the material web by each printing unit, wherein the printing units print simultaneously and wherein one of the plurality of printing marks printed by each printing unit constitutes a full tone mark. The relative position of at least one of the first and second cylinder pairs are adjusted within a predetermined range of relative positions according to a predetermined sequence. Colour selective detection of each of the printing marks for each adjusted relative position is performed. Actual tonal values are calculated from remission values obtained from the colour-selective detection for each of the printing marks and a print characteristics curve is established from the calculated actual tonal values, wherein the print characteristics curve plots the calculated actual tonal values against the known nominal tonal values of the printing marks. Print characteristics arrays are established from the calculated print characteristics curves, wherein a parameter of each print characteristics array includes at least one of the relative positions of the first and second cylinder pairs. Each established print characteristics array is compared with a target tonal value characteristic predetermined for the printing process to select a print characteristics curve that most closely matches the target tonal value characteristic. Full tone densities of each of the full tone marks are identified and full tone density characteristics for each adjusted relative position are plotted. The identified full tone densities are compared with a target full tone density predetermined for the printing process to select the identified full tone density that most closely matches the target full tone density. The relative position of at least one of the first and second cylinder pairs is adjusted based on the selected print characteristics curve and the selected full tone density.

### BRIEF DESCRIPTION OF THE DRAWING

FIG. 1 is a diagram of one embodiment of a printing press and a coupled control unit.

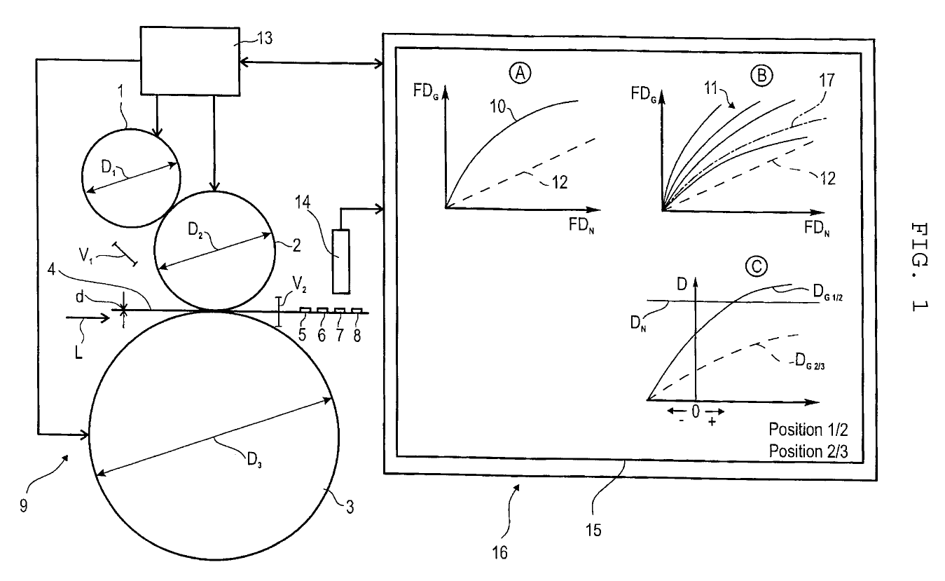

### WRITTEN DESCRIPTION

The appropriate adjusting of a roller group in a flexographic printing press, which includes at least the relative positioning of the plate cylinder with respect to the colour application roller (also referred to as anilox roll) configured to dye the printing plate with printing ink and the positioning of the plate cylinder with respect to the impression cylinder guiding the fabric to be printed, is related to a considerable consumption of material and time. Commonly, the positioning nowadays is performed such that, based on the geometric dimensions and positions of the colour application roller, the form cylinder, the material as well as the impression cylinder known per se, a relative positioning of all associated cylinders with respect to each other is calculated and then adjusted. In case a specific pressing between the two pairs forms the basis for the aim of the calculation, this results in a setting in which, due to this specific pressing, colour is also transported in both pairs and therewith a print is generated. Such kinds of powered pre-adjusting systems can nowadays be found in all modern machines.

However, it is inevitable that concrete production tolerances of the associated components, different elastic characteristics in particular in the structure of the printing block, deviations in the thickness of the material of the fabric to be printed, colour transfer characteristics etc. have an effect on the achieved printing result.

In each printing job, it is therefore still an object to adjust the machine such that a print with good quality is obtained and that, in particular, the printing block is not subjected to any unnecessary wear which reduces the service life of the block, the replacement of which constitutes a considerable expense factor.

In case a first adjustment is performed for a printing job in accordance with the geometric data, an additional correction is required to obtain optimum conditions.

Said correction is nowadays mostly performed manually in that the printer for example reduces the pressing until the printing no longer takes place and then again feeds in—the pressing is increased—until a printing can just be performed again. The printer monitors the result of his/her operations visually directly on the print web. This procedure is performed for both pairs of cylinders and for each printing block subsequently, while the machine is running. Possibly, the printer also uses a video web monitoring device which records an image of the printing result and displays them on a monitor.

In EP 1 249 346, a method and an apparatus is described which transfer the procedure mentioned above directly into an automatic process and therewith save the individual adjustments by performing same with motors.

The described method is an enhancement, however, exhibits a series of disadvantages. Therein, analogous to the operation of the printer, a sequence of adjustments of the pressing in the cylinder pairs is performed and their effects are respectively monitored on the printed image in an interactive manner by means of a camera-based inspection system which is known per se. For this purpose, at least two subsequent images are checked to determine whether the print shows less or more elements than the preceding image. Dependent on the result thereof, it is then respectively decided whether the pressing is increased or decreased. If a modification no longer occurs, the aim is reached and it is concluded that the print is completed. From the completeness of the print, an appropriate pressing in the respective pairs is derived in a manner which is not described in detail. This is disadvantageous, on the one hand, since this procedure has to be performed for each colour separately and subsequently and therewith a considerable amount of material is wasted despite the automation of the processes, and on the other hand, since the printing ink on the anilox roll or the form cylinder in the turned-off or not printing units can dry out, which leads to an additional washing/cleaning effort. Third, this method cannot take into consideration how a reproduction of colour values in the image is actually effected, such that this is normally left to the printer in additional subsequent adjusting steps. The high capital expenditure may not be neglected, which is required for the use of a full-scope inspection system for recording and evaluating images.

It is therefore an object of the invention to provide a method and an apparatus for optimally adjusting the infeed of a rotary flexographic printing press comprising multiple printing units, which make is possible to achieve a reduction of maculation and a control result being superiorly adapted to the requirements of the printing process with relatively simple technical means and low effort.

In case additional marks are placed besides the printed image constituting the actual printing product, same can be arranged such that marks printed by one printing unit may find a place spatially separated from the marks printed by an other printing unit (e.g. side-by-side or in series or combined in one block) and, thus, marks from all printing units are contained simultaneously in one print. Therewith, the stopping of the printing process in the printing units which are presently not used, that is normally required for differentiation, can be omitted and the colour does not dry out.

For an image reproduction with correct colours, it is essential that, in particular in case of an autotype four-colour printing, the reproduction of tonal values in the individual colours is effected correctly. In particular, this is determined considerably by the pressing, such that it is preferable to use the criterion of a correct tonal value reproduction instead of the simple Yes/No—criterion of a completeness of the print, said criterion being represented by the print characteristic (10, image 1—tonal value in print FDG dependent on the nominal tonal value FDN on the block). In case a plurality of marks with respectively different tonal values being known in their characteristics on the block are printed per colour, the features of the tonal value reproduction in the print can be derived from a measurement of the dot gain on the printed marks.

This procedure also evades the dilemma to have to generate or record a master for the judgment of a completeness, wherein the master represents the completeness. In a print shop, a predetermined dot gain is known for the printing process and a goal for a print with high quality. According to the invention, the target tonal value characteristic and the target full tone density are considered as criteria for the selection of an appropriate pressing.

For this purpose, the pressing between the anilox roll 1 and the form cylinder 2 and/or the form cylinder 2 and the impression cylinder 3 is varied on the basis of the calculated original setting of the pressing, e. g. in four procedural steps, and the print characteristic is respectively determined. The pressing in which the print characteristic comes closest to the target characteristic is then selected. For this purpose, it is not required to reduce the pressing such that the print process in the printing unit is stopped. It is sufficient to reach a minimum pressing in which the characteristic comes close to the nominal tonal value characteristic. Hence, sufficiently good information on the characteristic is gained by e.g. printing three marks having a surface coverage of 30%, 50% and 75%, which allows selection of the correct pressing. In case of a plurality of tonal value characteristics, the adjustment of the rolls is preferably performed on the basis of the characteristic which comes closest to the target tonal value characteristic 17. In a case when two characteristics are disposed approximately equally far from or close to the target tonal value characteristic 17, an adjustment according to an intermediate value is performed. This further includes the advantage that it is not necessary to add, based on the stopping of the printing process (or a no longer occurring increase of members), an empiric amount of pressing, but that it is possible to select an actually already realized value.

In addition to the described measurements at halftone mark fields, also a full tone field is printed. This full tone field then enables, based on the, in densitometry usually used, relation between pigment concentration per area unit and optical density, a conclusion on the thickness of the layer which was plotted onto the printed substrate by the colouring unit, and in particular concerning the question whether the optical density in printing intended for the printed product is present. Such parameters are e.g. known from in-house standards or also general standards or are predetermined as previously set target values. Simultaneously, the correct printing pressing between the pairs of cylinders may be concluded from a sufficient homogeneity of the colour plotting on a full tone field. Hence, there occur e.g. so-called squeeze edges upon a too strong pressing, whereas the printout is “flaky” upon a too weak pressing.

The determination of the correct pressing is obtained in that, beginning from the calculated pressing, two to three additional pressing settings are predetermined, e.g. X+50 μm, X-50 μm and X-100 μm, in which the printing characteristic is measured at one printed specimen or at a plurality of specimen, respectively, in order to obtain an average value. Already when manufacturing a printing block, a specific printing characteristic, namely the one typical for the machine with which a product shall be printed, was considered as known. Now, this expected characteristic is compared with the recorded characteristics and the pressing between the form cylinder and the impression cylinder coming closest to this characteristic is adjusted. Subsequently, the pressing between the printing plate and the anilox roll is varied in the same way and the pressing is used with which the characteristic corresponds to the parameters and, furthermore, the full tone mark and its characteristics comes closest to the parameters.

For measuring the colour density on the full tone fields or halftone fields, respectively, methods and devices are used as are used e.g. in known inline density measuring devices in offset printing. Such sensing heads consist e.g. of a remission sensing head which has, between the optical axis of the illumination and that of the measuring value recording device, a geometry of 0°/45°, 45°/0°, is provided with a plurality of optical filters being selected such that an influence by the used colours being as high as possible for all measured colours occurs or complies with the usual standards for this purpose, respectively, and comprises a device for synchronizing the moment of the measuring with the printed product. Equally, the optical principle may e.g. be reversed in that the illumination is obtained in selected spectral ranges and the detection is then performed without colour filters or also a combination of both.

In the following, a possible procedure according to the invention is described as an example:

The first pressing within a pair of cylinders is adjusted, e.g. the calculated pressing +50 μm.

The aforementioned measured colour density values are now registered by the full tone fields and halftone fields and the printing characteristic is construed therefrom. Then, the pressing within a pair of cylinders is reduced by a fixed value and a characteristic is again generated for the new pressing. In the next steps, this procedure is repeated such that an array of characteristics is obtained, wherein one characteristic is respectively associated with one pressing setting. In addition, the characteristic being presupposed when manufacturing the printing block as a characteristic for the printing machine is inserted. Now, a change in the second pressing pairing is performed, which is run in the same manner. Simultaneously, the full tone field is continuously measured, for which also a target full tone density may be considered as known.

Finally, a setting of the pairs is selected which comes nearest to the required target density parameters as well as to the required print characteristic.

None of the aforementioned procedures requires a complete shut-down of the printout or the removal of printing members.

In case the measurement is performed by using a densitometric sensing head, it supplies values for the colour density as well as values for an optical area coverage which is preferably calculated on the basis of the known Morey-Davis-Equation. Therewith, a sensing head may detect a plurality of subsequent marking fields in one pass below the sensor, such that the number of specimen required for the measuring is further reduced.

A further advantageous embodiment of the invention lies in the fact that an adjustment of the pressing between the pairs of cylinders is performed continuously between two defined thresholds instead of a stepwise adjustment of the pressing, and the correct pressing is respectively assigned to a measurement on the basis of the knowledge of the chronological sequence and the path length between the pressure contact and the position of the sensor.

Alternatively, the recording of the colour density values and the optical area coverage may be performed by a camera for which an illumination geometry is provided that is similar to the described 0/45 or 45/0 arrangements. In this way, a plurality of measuring fields may likewise be detected within one format and it is not required to install a separate measuring device in the machine. Although normal RGB cameras do not comprise suitable filters for measuring a colour density, same can be utilized in appropriate cases in favour of a fast operation, as is described e.g. by Künzli, Noser, Loger and Murad (EMPA, St. Gallen 1993).

In order to adapt to the situation in a machine or the printing block, it may be useful to arrange the respective measuring fields several times across the width of the printout. Therewith, slight deviations from parallelness or flatness of the associated cylinders and blocks can be registered and compensated by averaging.

The only figure of the drawing shows a schematically strongly simplified depiction of an inventive apparatus for optimally adjusting the infeed in a rotary flexographic printing machine comprising a plurality of printing units 9, wherein only one printing unit 9 is shown in a schematically strongly simplified manner to represent all printing units.

The printing unit 9 comprises an anilox roll 1 having a diameter D1. Further, the printing unit 9 comprises a form cylinder 2 having a diameter D2, which cooperates with the anilox roll 1 and is adjustable with respect to same through an adjusting range V1, in order to be able to adjust the pressing between the anilox roll 1 and the form cylinder 2.

Further, the printing unit 9 comprises an impression cylinder 3 having a diameter D3, which cooperates with the form cylinder 2 to guide a material web 4 to be printed. The relative position between the form cylinder 2 and the impression cylinder 3 may be adjusted along an adjusting range v2.

The inventive apparatus further comprises a control unit 16 which is provided with a calculating unit 15. Further, an actuator 13 for adjusting the relative position between the anilox roll 1 and the form cylinder 2 as well as the form cylinder 2 and the impression cylinder 3 is provided. The actuator 13 is in signal communication with the control unit 16 to exchange information on position and status.

The apparatus further comprises a colour-selective sensor 14 which is in signal communication with the calculating unit 15 and the control unit 16 to exchange measuring data and control information for the measuring value detection.

As is made clear by the figure, the printing unit 9 prints a series of printing marks 5, 6, 7 and 8 onto the material web 4 in the example. Herein, the mark 8 constitutes a full tone mark.

The colour-selective sensor 14, which is always arranged behind the printing units 9 when viewed in the running direction L of the web, detects the printing marks 5 to 8 for a plurality of adjusting steps between the anilox roll 1 and the form cylinder 2 in accordance with the predetermined adjusting range V1 or between the form cylinder 2 and the impression cylinder 3 in accordance with the adjusting range V2. The result of the measurement is respectively transmitted to the calculating unit 15.

In said calculating unit, actual tonal values FDG are calculated from the remission values resulting from the colour-selective detection for each of the printing marks 5 to 8. Further, a printing characteristic 10 is generated from the calculated actual tonal values FDG, which plots the calculated actual tonal values FDG over known nominal tonal values FDN of the printing marks 5 to 8 (diagram A).

Further, arrays of printing characteristics 11 are generated, wherein the relative change of position between the anilox roll 1 and the form cylinder 2 or the form cylinder 2 and the impression cylinder 3, respectively, said relative change being set when recording the characteristic, represents the array parameter.

Further, a target tonal value characteristic 17 preset for the printing process and considered for the printing block manufacturing is entered into the diagram and this characteristic 17 is compared with the determined printing characteristic 11 in the calculating unit 15 (diagram B).

In a next method step, the detected full tone densities DG of the full tone mark 8 are evaluated in accordance with the relative position of the cylinders, which results in further characteristics DG1/2, DG2/3, as is discernible from the figure (diagram C).

The measured or calculated full tone densities DG of the full tone mark 8 are compared with a target full tone density DN being preset for the printing process and considered when manufacturing the printing block.

Finally, according to the invention, the adjustment of the relative position between the anilox roll 1 and the form cylinder 2 and between the form cylinder 2 and the impression cylinder 3 is determined and adjusted by the actuator 13, in which the tonal value characteristic comes closest to the target tonal value characteristic 17 and the full tone density comes closest to the target full tone density DN.

Although this does not result in detail from the schematically strongly simplified depiction in the figure, it is possible according to the invention to dispose the colour-selective sensor 14 on a traverse above the material web 4 in a manner to be movable to the respective measuring position by motor control.

Further, it is possible to arrange respectively one colour-selective sensor 14 at the left and right sides of the material web 4.

As possible variations of the embodiment for the colour-selective sensor 14, e. g. a colour density measuring device or a video camera known per se is conceivable.

Further, a sensor line may be used as a further embodiment of the colour-selective sensor 14, said sensor line being arranged in the running direction of the web and consisting of members having different spectral sensitivity arranged in series.

As an alternative, a sensor line being arranged in the running direction of the web may be used as the colour-selective sensor, in which, when performing subsequent measurements, respectively one filter having different spectral characteristics is arranged upstream.

Definitions

Tonal value: Unit (in %) for the portion of a property within an area, which only comprises the two properties “0” and “1” (in the present case, the properties are regularly properties of optical nature).

Nominal tonal value: Nominal tonal value designates a tonal value which is assigned to an area as a property per definition.

Dot gain: The dot gain being affected by a procedural step designates the difference of the tonal value after the process compared to the tonal value before the process. In the present case, the difference between the tonal value after the printing and the nominal tonal value 12 is meant.

Full tone mark: Mark with 100% area coverage (reference marks)

Colour-selective detection: Remission measuring, during which it is detected how much light from a mark is remitted to a predetermined spectral area.

Target tonal value: The tonal value an area shall have as a result of a processing.

Tonal value characteristic: A curve wherein on the one axis of an X-Y-coordinate system the nominal tone values are plotted and the assigned tonal values of the respectively same area are plotted on the other axis. A typical procedure in printing processes is e.g. that the nominal tonal values are plotted on the one axis and the actual tonal values are plotted on the other axis after passing a processing step.

Target tonal value characteristic: A tonal value characteristic in which nominal tonal values are plotted on the one axis and the target tonal values are plotted on the other axis.

Target full tone density: A predetermined full tone density value which shall be achieved.

### LIST OF REFERENCE NUMERALS

1 anilox roll
2 form cylinder
3 impression cylinder
4 material web/printing web
5-8 printing marks
9 printing unit
10 printing characteristics curve
11 array of printing characteristics
12 tonal value characteristic without drop gain
17 target tonal value characteristic
V₁ adjusting range between 1 and 2
V₂ adjusting range between 2 and 3
FD_{G} actual tonal value
FD_{N} nominal tonal value
D_{N} target full tone density
D_{G} measured or calculated full tone density

What is claimed is:

1. A method comprising:
calculating, for each of a plurality of printing units in a printing press, a relative position between an anilox roll and a form cylinder that form a first cylinder pair and a relative position between the form cylinder and an impression cylinder that form a second cylinder pair, wherein the impression cylinder guides a material web for a printing process;
printing a plurality of printing marks having different and known nominal tonal values onto different locations of the material web by each printing unit, wherein the printing units print simultaneously and wherein one of the plurality of printing marks printed by each printing unit constitutes a full tone mark;
adjusting the relative position of at least one of the first and second cylinder pairs within a predetermined range of relative positions according to a predetermined sequence;
performing colour selective detection of each of the printing marks for each adjusted relative position;
calculating actual tonal values from remission values obtained from the colour-selective detection for each of the printing marks and establishing a print characteristics curve from the calculated actual tonal values, wherein the print characteristics curve plots the calculated actual tonal values against the known nominal tonal values of the printing marks;
establishing print characteristics arrays from the calculated print characteristics curves, wherein a parameter of each print characteristics array includes at least one of the relative positions of the first and second cylinder pairs;
comparing each established print characteristics array with a target tonal value characteristic predetermined for the printing process to select a print characteristics curve that most closely matches the target tonal value characteristic;
identifying full tone densities of each of the full tone marks and plotting full tone density characteristics for each adjusted relative position;
comparing the identified full tone densities with a target full tone density predetermined for the printing process to select the identified full tone density that most closely matches the target full tone density; and
adjusting the relative position of at least one of the first and second cylinder pairs based on the selected print characteristics curve and the selected full tone density.

2. A method for optimally adjusting the infeed in a rotary flexographic printing press having a plurality of printing units by adjusting relative positions in each printing unit between an anilox roll and a form cylinder and between the form cylinder and an impression cylinder guiding a material web for a printing process, the method comprising:
calculating a relative position of the anilox roll and the form cylinder of each printing unit based on known diameter values thereof and calculating the relative position of the form cylinder and the impression cylinder based on known diameters thereof as well as a thickness and a type of the material web;
printing a plurality of printing marks having different and respectively known nominal tonal values onto different locations of the material web by each printing unit, wherein the printing units print simultaneously and one of the plurality of printing marks printed by a printing unit constitutes a full tone mark;
performing colour-selective detection of the plurality of printing marks for a plurality of adjusting steps in a predetermined sequence and within predetermined adjusting ranges of at least one of the relative positions between the anilox roll and the form cylinder and between the form cylinder and impression cylinder;
calculating actual tonal values from remission values resulting from the colour-selective detection for each of the plurality of printing marks and establishing a print characteristics curve from the calculated actual tonal values, wherein the print characteristics curve plots the calculated actual tonal values over the known nominal tonal values of the plurality of printing marks;
establishing print characteristics arrays from the calculated print characteristics curves, wherein the relative position adjustment of at least one of the anilox roll and form cylinder and the form cylinder and impression cylinder when recording a print characteristics curve represents the array parameter;
comparing the print characteristics arrays with a target tonal value characteristic predetermined for the printing process;
identifying full tone densities of the full tone marks and plotting full tone density characteristics over the adjusted relative position between at least one of the anilox roll and the form cylinder and between the form cylinder and impression cylinder;
comparing the identified full tone densities of the full tone mark with a target full tone density which is predetermined for the printing process;
determining adjustments of the relative position between the anilox roll and the form cylinder and between the form cylinder and the impression cylinder based on a print characteristics curve that most closely matches the target tonal value characteristic, and based on a full tone density that most closely matches the target full tone density; and
adjusting at least one of the relative positions between the anilox roll and the form cylinder and between the form cylinder and the impression cylinder based on the determined adjustments.

3. The method of claim 2 wherein a homogeneity of the full tone mark of each printing unit is detected by a measurement at different locations on the full tone mark in addition to the target full tone density, and wherein the full tone density that most closely matches the target full tone density is determined as most closely matching only if the homogeneity does not fall below a specific homogeneity degree.

4. The method of claim 2 wherein an order-specific target tonal value characteristic is used for a client's order.

5. The method of claim 2 wherein a calculating unit calculates the adjustments for the positioning of the anilox roll and form cylinder and the form cylinder and impression cylinder from a plurality of printing characteristics curves most closely matching the target tonal value characteristic, wherein the adjustments are transmitted to an actuator.

6. The method of claim 1 wherein the printing marks are arranged and scanned at plural locations of the material web.

7. The method of claim 6 wherein the printing marks are located and scanned respectively at the left and right edges of the material web.

8. The method of claim 7 wherein a parallel position of the anilox roll and form cylinder and the form cylinder and impression cylinder is adjusted by values determined for the respective edge of the material web and transmitted to a control unit.

9. A method for optimally adjusting the infeed in a rotary flexographic printing press having a plurality of printing units by adjusting relative positions in each printing unit between an anilox roll and a form cylinder and between the form cylinder and an impression cylinder guiding a material web for a printing process, the method comprising:
calculating a relative position of the anilox roll and the form cylinder of each printing unit based on known diameter values thereof and calculating the relative position of the form cylinder and the impression cylinder based on known diameters thereof as well as a thickness and a type of the material web;
printing a plurality of printing marks having different and respectively known nominal tonal values onto different locations of the material web by each printing unit, wherein the printing units print simultaneously and one of the plurality of printing marks printed by a printing unit constitutes a full tone mark;
performing colour-selective detection of the plurality of printing marks for a plurality of adjusting steps in a predetermined sequence and within predetermined adjusting ranges of at least one of the relative positions between the anilox roll and the form cylinder and between the form cylinder and impression cylinder;
calculating actual tonal values from remission values resulting from the colour-selective detection for each of the plurality of printing marks and establishing a print characteristics curve from the calculated actual tonal values, wherein the print characteristics curve plots the calculated actual tonal values over the known nominal tonal values of the plurality of printing marks;
establishing print characteristics arrays from the calculated print characteristics curves, wherein the relative position adjustment of at least one of the anilox roll and form cylinder and the form cylinder and impression cylinder when recording a print characteristics curve represents the array parameter;
comparing the print characteristics arrays with a target tonal value characteristic predetermined for the printing process;
identifying homogeneities of the full tone marks and plotting respective characteristics over the adjusted relative position between at least one of the anilox roll and the form cylinder and the form cylinder and impression cylinder;
comparing the identified homogeneities of the full tone mark with a target homogeneity which is predetermined for the printing process;
determining adjustments of the relative position between the anilox roll and the form cylinder and between the form cylinder and the impression cylinder based on a print characteristics curve that most closely matches the target tonal value characteristic, and based on a homogeneity that most closely matches the target homogeneity; and
adjusting at least one of the relative positions between the anilox roll and the form cylinder and between the form cylinder and the impression cylinder based on the determined adjustments.

10. An apparatus for optimally adjusting the infeed in a rotary flexographic printing press having a plurality of printing units by adjusting relative positions in each printing unit between an anilox roll and a form cylinder and between the form cylinder and an impression cylinder guiding a material web for a printing process, the apparatus comprising:
a control unit including a calculating unit;
an actuator configured to adjust the relative positions between the anilox roll and the form cylinder and between the form cylinder and the impression cylinder of each printing unit, wherein the actuator is in signal communication with the control unit for exchanging information on position and status; and
a colour-selective sensor in signal communication with the calculating unit and the control unit for exchanging measuring data and control information for the detection of measuring data.

11. The apparatus of claim 10 wherein the colour-selective sensor is movable to a plurality of measuring positions by motor control on a traverse.

12. The apparatus of claim 10 wherein first and second colour-selective sensors are disposed on the left and right sides, respectively, of the printing web.

13. The apparatus of claim 10 wherein the colour-selective sensor is a colour density measuring device.

14. The apparatus of claim 10 wherein the colour-selective sensor is a video camera.

15. The apparatus of claim 10 wherein the colour-selective sensor is a sensor line arranged in a running direction of the material web, wherein the sensor line includes members having different spectral sensitivities that are arranged in series.

16. The apparatus of claim 10 wherein the colour-selective sensor is a sensor line arranged in a running direction of the material web, and wherein a filter having different spectral characteristics is coupled upstream of the sensor line when subsequent measurements are conducted.
